(19) United States
(12) Patent Application Publication
(10) Pub. No.: US 2002/0161833 A1
(43) Pub. Date: Oct. 31, 2002

(54) Methods for registering and notifying wireless devices

(76) Inventors: Bruce David Gordon Niven, Arvada, CO (US); Giles Francis Stewart Payne, Linlithgow (GB)

Correspondence Address: BRUCE NIVEN, 7626 OAK STREET, ARVADA, CO, 80005, US

(21) Appl. No.: 10/081,476

(22) Filed: Feb. 22, 2002

(30) Foreign Application Priority Data
Feb. 28, 2001 (GB) 0105008.7

(51) Int. Cl. G06F 15/16

(52) U.S. Cl. 709/203; 709/227

(57) ABSTRACT

The invention relates to a method of registering a client wireless device for an event, and to a method of alerting registered client wireless devices, which may not be connected, that the event is about to commence. Both methods take advantage of the fact that wireless devices often have permanent unique identification numbers associated with then, and that it is possible to send a timed message to a wireless device which may or may not be connected to an event server at that time. Together these steps allow a participant in a live interactive event to pre-register and enter the event with the minimum number of user actions, and without needing to remember him/herself to re-enter the event site at the appropriate time.

### CROSS REFERENCE TO RELATED APPLICATIONS

Priority is claimed for this application from British patent number 0105008.7 filed on Feb. 28, 2001 by the above named inventors.

### BACKGROUND

1. Field of Invention

The present invention relates to methods for registering wireless devices such as WAP or other advanced mobile telephones on registration servers and for notifying client wireless devices of an impending event.

2. Description of Prior Art

U.S. Pat. No. 6,012,984 discloses a gaming system that allows a large arena of participants to interactively play a game of chance or skill from computer terminals over the internet.

The internet has made multi-user interactive events possible. The disadvantage with the present systems is that because computer terminals are often used by multiple users, each time a user participates in an interactive event registration details unique to that user must be entered. The entering of such details is time-consuming and can lead to errors. Furthermore most computer terminals do not have a permanent unique identifier detectable by the service provider, and automated registration for an interactive event can only be achieved by storing code on the client device, such as a cookie.

Another problem with existing multi-user interactive event sites is that they typically run events continuously. While this has the advantage of convenience, the disadvantage is that such sites are usually able to attract tens rather than hundreds or thousands of participants at any one time. The present invention solves this problem by allowing for infrequent events combined with instant messaging event reminder notifications, thereby maximising potential event participation.

Computer terminals connected to the internet via a dial-up connection typically use an Internet Protocol (IP) number in the network layer (layer 3) of the Open Systems Interconnection (OSI) seven layer model, which is temporarily assigned by the Internet Service Provider (ISP) during log-on. Those familiar with the OSI model will be aware of the fact that the lowest layer corresponds with some kind of physical communication which may be established using an underlying tele-communication network such as a conventional telephone system in the case of a dial-up connection. Devices, which operate on a switched tele-communication network such as mobile cellular networks, have a unique identification code i.e. simply their “telephone number”. These identifiers are used in establishing communication over the communication network. In the realm of cellular technology, a caller line identity (CLI) is optionally attached to the “header” of a call setup session. The CLI is usually the telephone number. Wireless devices often have SIM cards on which the unique identification code is stored. The code on the SIM card may or may not be the telephone number of the wireless device. If not, the phone number may be stored in the network and mapped to the unique identification code on the SIM card. The present invention takes advantage of the fact that the unique identification code does not vary for a given device without user interference and the fact that the unique identification code must be rented from a service provider. The unique identification code also provides a means for sending instant messages to non-connected client wireless devices over a telecommunications network such as a SMS message.

U.S. Pat. No. 5,738,583 discloses a gaming system using a plurality of pagers. Although no method of registering is explicitly explained, from the flow chart of FIG. 4 it is clear that a participant list 48 and a game grid 49 have contact information for client wireless devices registered for a particular game. However, this information is not stored when the participant exits from the game. The present invention comprises the step of storing unique registration information in a database and a further step of disconnecting the client wireless device and registration server while still maintaining the unique identification code in the database, in order to allow participants to be reminded of, and to reconnect to, future events in a highly simplified manner.

EP-A2-0,977,451 discloses a system in which mobile telephones can download software from an internet site. The internet site has a database of International Mobile Equipment Identity (IMEI) codes, which uniquely identify the phone, and includes a Type Approval Code (TAC), a Final Assembly Code (FAC) identifying the assembly plant and a serial number (SN). From column 8, lines 39 to 44 it can be seen that the purpose of this database is to check whether the participant phone has an open account for paying for the requested software. No details are given as to how the IMEI code is placed into that database, which could be provided for example by the device manufacturer. The present invention comprises one possible method of registering devices in a highly simplified way, which makes use of the fact that unique identification numbers may be transmitted when a wireless device connects to an internet site and these may be stored in a database for correlation when the device connects again to that site in future. The present invention furthermore allows these registered participants to be reminded automatically of an impending interactive event.

JP 2001104649, of which only an English translation of the abstract is available, describes a data communication method in a game system, involving the sending the transmitting file produced by a game terminal to a server which checks the login ID of the received transmitting file. The received transmitting file is added to the registration file of a game convention when the received transmitting file has the same login ID as the login ID of a predetermined transmitting file group. The present invention relates specifically to wireless devices connecting to a game server, and makes use of the fact that wireless devices may automatically transmit a unique identifier, which can be stored in a database and is constant even if the participant disconnects and then reconnects to the game server. Thus the registration process, specifically the initial storage of the unique identification number in the database, is considerably simplified in the present invention.

### SUMMARY

In the first aspect of the present invention, there is provided a method of registering a client wireless device, comprising the steps of:

operating a registration server for generating registration page signals;

allowing at least one gateway server to connect to said registration server;

allowing a client wireless device with a unique identification code to connect to said registration server through said gateway server;

sending said client wireless device said registration page signals;

detecting said unique identification code; and

registering said unique identification code in response to receipt by said registration server of a registration request signal from said client wireless device.

In the second aspect of the present invention, there is provided a method for notifying a client wireless device of an impending event, comprising the steps of:

operating an event server for registering client wireless devices and generating event page signals;

allowing at least one gateway server to connect to said event server;

providing a registration process for registering client wireless devices before said event;

allowing registered client wireless devices to connect to said event server through said at least one gateway server to participate in said event;

providing a notification server connected to said event server; and

sending, through said notification server, a predetermined time before said event, a reminder message to said registered client wireless devices not connected to said event server.

The advantage of this registration method is that registration will only be necessary once for a multiple number of interactive events. The invention takes advantage of the ability of the event server automatically to detect and store the unique identification code of the client wireless device such that as soon as the client wireless device connects to the event server, the event server is aware of which (registered) client wireless device has connected.

The advantage of this reminder method is that because a unique identity code of a registered client wireless device is known by the event server, reminder messages can be sent to registered client wireless devices not connected to the event server just before the event starts.

In combination these two methods form a highly simplified and effective method for people wishing to participate in an event to do so. They need only visit the site at any time, whereupon their device's unique identifier is automatically stored, and they will automatically receive a reminder message shortly before event time, even if not connected to the site at that time.

The present invention also provides an apparatus for performing the methods of the present invention in a computing system, the computing system having a processor, an input/output device, and a data storage device, said apparatus comprising modules to perform each step of said methods.

The present invention further provides a computer program for executing a computer process, the computer program being storage medium readable by a computing system and encoding a program of instructions for performing the methods of the present invention.

The above computer-implemented steps in another implementation of the invention are provided as an article of manufacture, ie. a computer program being storage medium readable and containing a computer process for performing the above described steps.

### DRAWING FIGURES

The invention will be described by way of example only, with reference to the accompanying drawings in which:

FIG. 1 illustrates a computer network connected to a wireless telecommunication network for providing multi-user interactive events;

FIG. 2 illustrates an example of a participant client wireless device interface suitable for operating on the system depicted in FIG. 1;

FIG. 3 illustrates an embodiment of event server daemon process suitable for operating on the system depicted in FIG. 1;

FIG. 4 illustrates one embodiment of a software system suitable for configuring the event server depicted in FIG. 1;

FIG. 5 illustrates an embodiment of the configuration of a gateway server suitable for configuring a gateway server as depicted in FIG. 1;

FIG. 6 illustrates a software system suitable for operating on the client station of FIG. 1; and

FIG. 7 depicts an example basic structure of the event server database.

### REFERENCE NUMERALS IN DRAWINGS

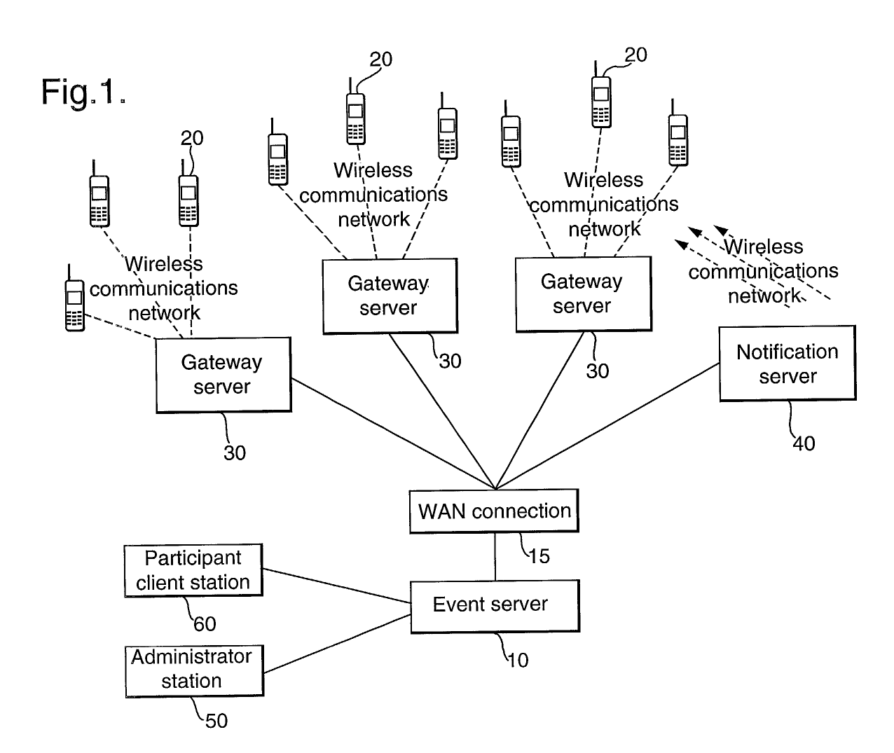

REFERENCE NUMERALS IN DRAWINGS
From FIG. 1:

| | | | |
|---|---|---|---|
| 10 | Event Server | 15 | WAN Connection |
| 20 | Client Wireless Device | 30 | Gateway Server |
| 40 | Notification Server | 50 | Administrator Station |
| 60 | Participant Client Station | | |

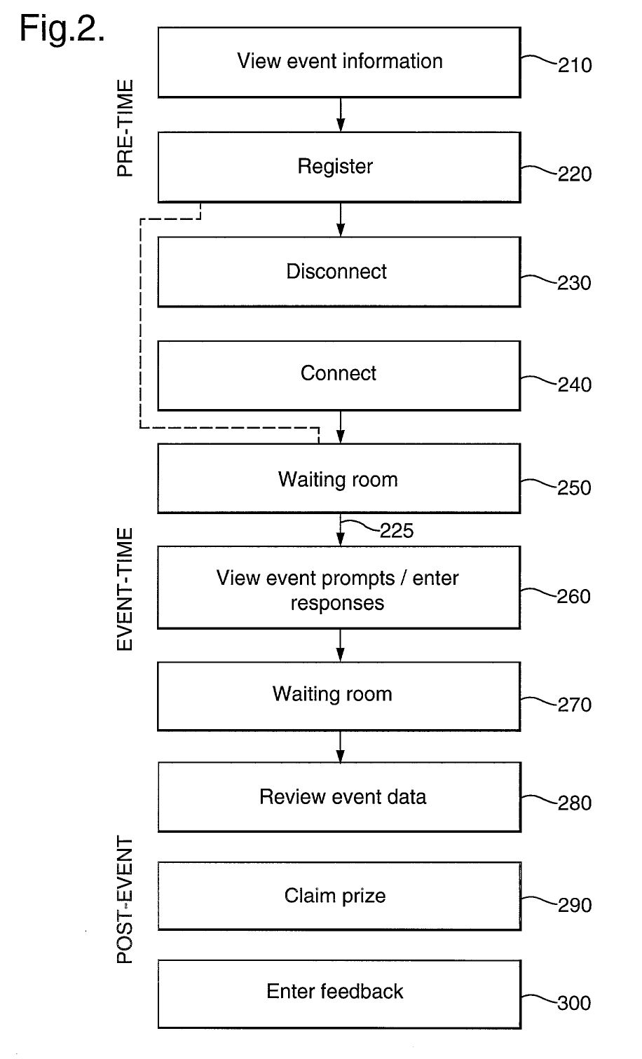

From FIG. 2:

| | | | |
|---|---|---|---|
| 210 | View Event Information | 220 | Register |
| 230 | Disconnect | 240 | Connect |
| 250 | Waiting Room | 260 | View Event Prompts/Enter |
| | | | Responses |
| 270 | Waiting Room | 280 | Review Event Data |
| 290 | Claim Prize | 300 | Enter Feedback |

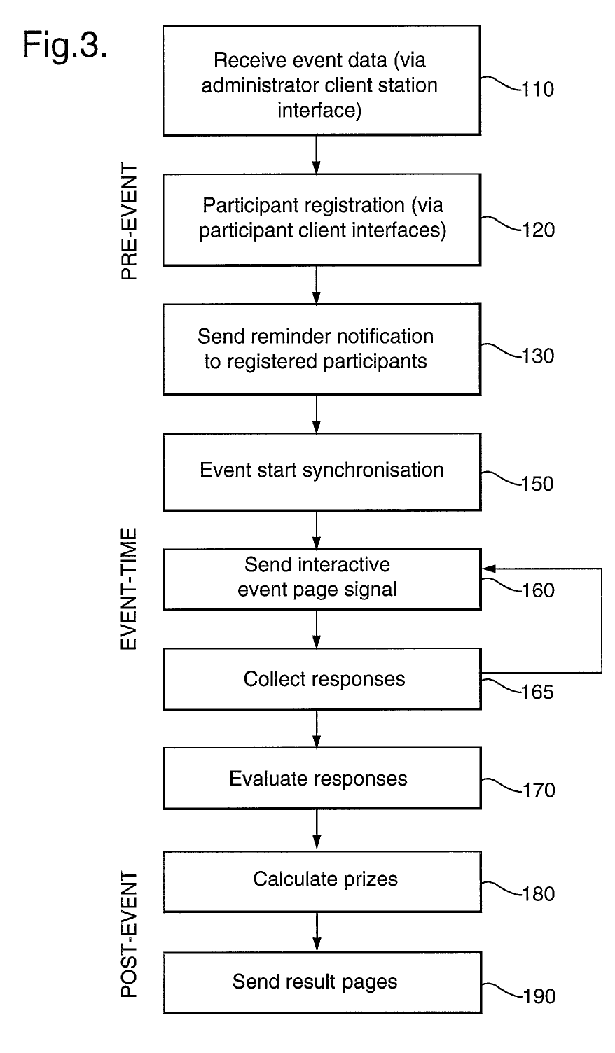

From FIG. 3:

| | | | |
|---|---|---|---|
| 110 | Receive Event Data | 120 | Participant Registration |
| 130 | Send Reminder Notifica- | 150 | Event Start Synchronisation |
| | tion | | |
| 160 | Send Interactive Event | 165 | Collect Response |
| | Page Signal | | |
| 170 | Evaluate Response | 180 | Calculate Prizes |
| 190 | Send Results Pages | | |

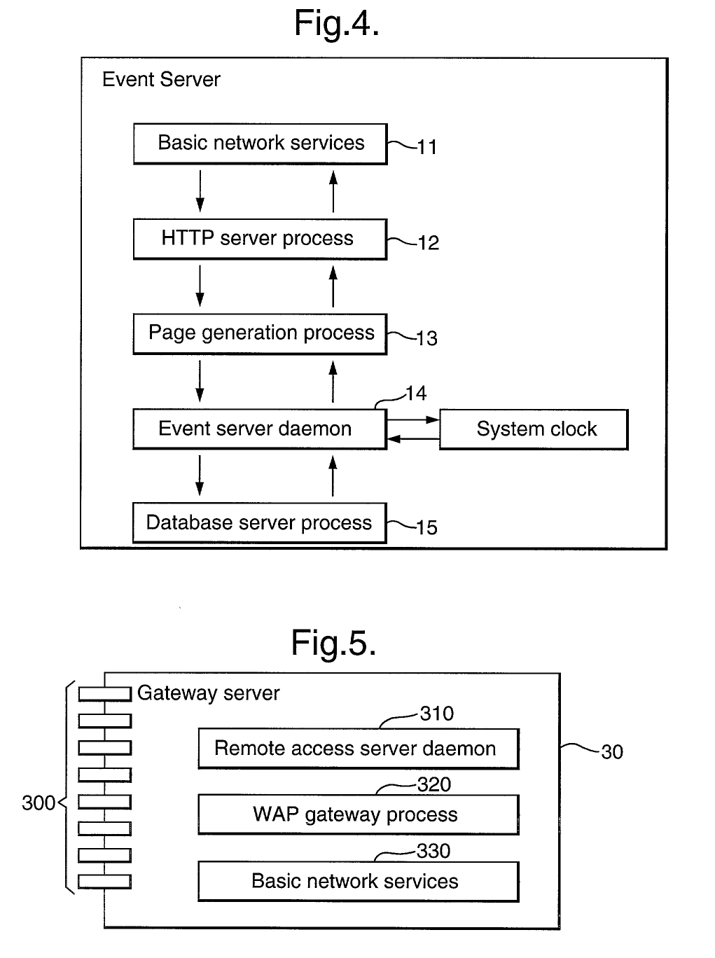

From FIG. 4:

| | | | |
|---|---|---|---|
| 11 | Basic Network Services | 12 | HTTP Server Process |
| 13 | Page Generation Process | 14 | Event Server Daemon |
| 15 | Database Server Process | | |

From FIG. 5:

| | | | |
|---|---|---|---|
| 300 | Modems | 310 | Remote Access Server Daemon |
| 320 | WAP Gateway Process | 330 | Basic Network Services |

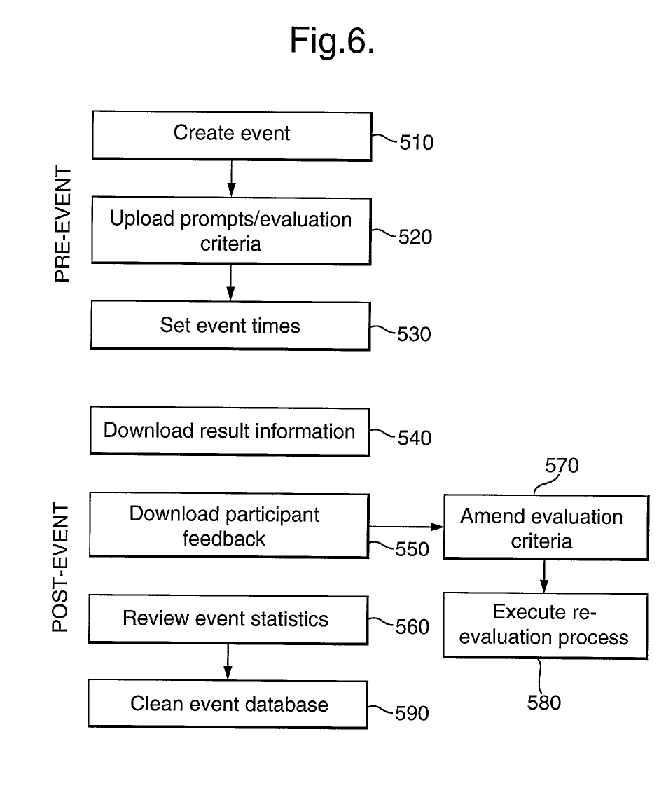

From FIG. 6:

| | | | |
|---|---|---|---|
| 510 | Create Event | 520 | Upload Prompts/Evaluation |
| | | | Criteria |
| 530 | Set Event Times | 540 | Download Results Information |
| 550 | Download Participant | 560 | Review Event Statistics |
| | Feedback | | |
| 570 | Amend Evaluation | 580 | Execute Reevaluation Process |
| | Criteria | | |
| 590 | Clean Event Database | | |

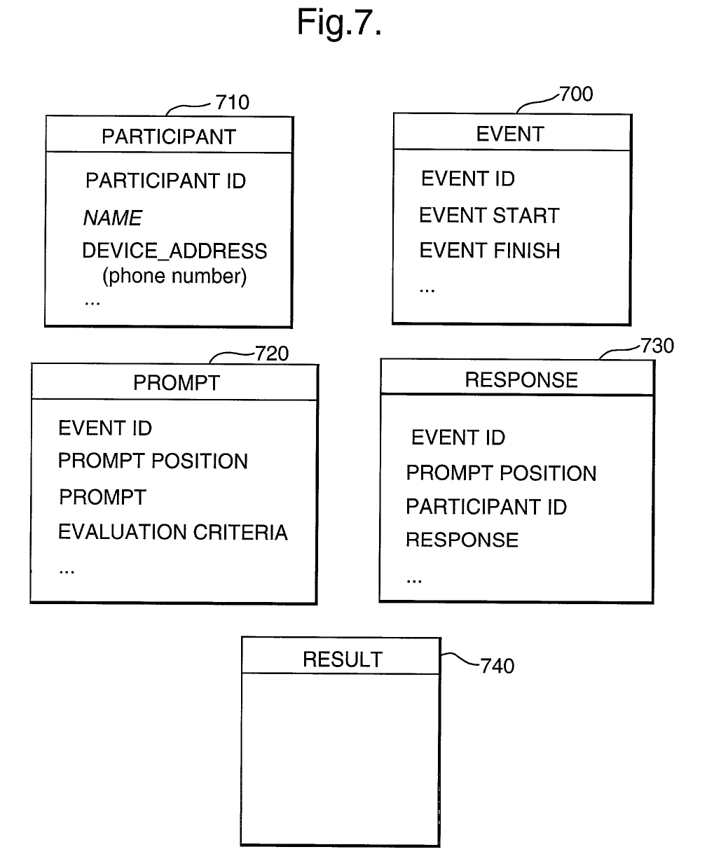

From FIG. 7:

| | | | |
|---|---|---|---|
| 700 | Event | 710 | Participant |
| 720 | Prompt | 730 | Response |
| 740 | Result | | |

Description—Embodiments of the Invention

The embodiments of the invention described herein involve the interaction of client-side and server-side processes, which may be implemented in software running on a computer or, particularly in the case of the client side, in dedicated hardware.

FIG. 1 illustrates a system capable of performing the method of the present invention. The system comprises an event server 10 connected through a wide area network (WAN) connection 15 to a plurality of gateway servers 30 and a notification server 40. A plurality of client wireless devices 20 can simultaneously connect to the event server 10 through a gateway server 30 and the WAN connection 15.

The event server 10 is controlled by an administrator client station 50 depicted in FIG. 1 directly connected to the event server 10. It is also possible, as illustrated, for client stations 60 to connect directly to the event server 10 over the internet.

The computer platform of the event server 10, the gateway servers 30 and the notification server 40 can be any number of widely available server platforms such as a DELL or a Sun Ultrasparc. The WAN connection 15 can be over the internet and the client wireless devices 20 can be any of a number of widely available mobile communications devices containing a modem and a micro-browser capable of processing and displaying page data received (WML or XML pages for example). One example of such a device is a WAP telephone (eg. the NOKIA 7110) and such devices also include devices using services offered over public mobile telecommunications networks, including, but not limited to, subscriptions on GSM, PCS, DCS, GPRS, PDC, UMTS, 3^{rd} Generation Mobile, 4^{th} Generation Mobile, CDMA, W-CDMAOne, CDMA 1XRTT, CDMA 2XRTT, TDMA, EDGE, CDMA 2000, TETRA, AMPS, D-AMPS and Nextel Networks. The client and administrator stations can be a conventional personal computer such as a PC compatible computer system with a browser program installed such as NETSCAPE NAVIGATOR.

One possible embodiment of the notification server 40 consists of conventional computer hardware and a short message service (SMS) message centre software process connected to a mobile switching centre of a wireless communication network.

It will be apparent to one skilled in the art that the event server 10, the gateway servers 30 and the notification server 40 can comprise conventional commercially available computer hardware configured by the operator of computer software to operate methods according to the invention. Those servers may in fact be processes running on the same machine. Further, it will be apparent to one skilled in the art that several server machines acting as a cluster may in fact substitute each server.

### DESCRIPTION—PREFERRED EMBODIMENT OF THE INVENTION

A specific application of a method for providing a multi-user interactive event will now be described by way of example. The method can be used to provide a nationwide real-time quiz game played by participants on client wireless devices such as mobile telephones. By real-time it is meant that the event has a predetermined start and finish time, within which participant responses must be received. Participants must register their intention to play before the event starts, pay an entry fee and answer a number of multiple-choice general knowledge questions during the event. Cash prizes are then awarded for those players with the most number of questions right.

FIG. 2 illustrates the progression of an interactive event as seen by a client wireless device 20 on which a participant is playing.

Before the event it is necessary for the participant to register his intention of playing in the interactive event. To accomplish this the event (or registration) server 10 allows client wireless devices 20 of prospective participants to connect to the event server 10 through one of the plurality of gateway servers 30 before the interactive event. Interactive event information such as time of event, entry fee, terms and conditions and instructions on how to play the game, can be viewed before registration takes place (step 210). In the illustrated embodiment this is a set of WML or XML pages to be displayed on client wireless device. The registration method takes advantage of a unique property of client wireless devices 20 such as those described above which is that they have a unique identification code (for example their respective telephone number). The event server 10 can be passed the unique identification code and also, if required, the type of client wireless device (such as the make and model of telephone) by the gateway server 30 which is sent that information by the client wireless device 20.

The unique properties of client wireless devices results in easy registration (step 220). The connected client wireless device 20 is sent registration page signals including a registration button by the event server 10. On selection of the registration button by the prospective participant a registration request signal is sent by the client wireless device of the participant to the event server 10.

On receipt of a registration request signal from a client wireless device 20, the event server 10 stores the unique identification code of the client wireless device, which sent the request signal and, optionally, the wireless device type. In this way, an operator of a client wireless device can send a registration request by only one participant action (e.g. a single “click”), without needing to enter details of the phone number for example. Once the client wireless device is registered, page signals, which is to say signals representing textual or graphical information in, for example, HTML, XML or WML format and possibly, to the extent practicable, audio visual data, confirming registration are sent to said client wireless device 20 and the client wireless device 20 may be disconnected from the event server 10 (step 230) or the participant may proceed directly to the interactive event.

If the event server 10 is not capable of automatically detecting the unique identification code of the client wireless device 20 (for example because that feature has been disabled by the participant) registration can take place by manual entry by the participant of the telephone number or other unique identification code. Registration is also possible via a client station 60. As will be seen below, there are several advantages to using the unique identification code to identify users.

The real-time interactive event takes place between start and finish times set by an event operator on the administrator station 50.

A short time before the start of the event it is necessary to connect to the event server 10. This can be a fresh connection 240 in which case the event server recognizes whether or not the client wireless device 20 has registered for the game by detecting the unique identification code of the client wireless device 20 or, if that feature is not enabled on the client wireless device, requires the unique identification code to be entered. If the unique identification code of the client wireless device is not recognized as a registered unique identification code, the client wireless device will be given the option to re-register or re-enter the unique identification code. On recognition of the unique identification code of the client wireless device 20 the procedure continues to the waiting room 250. Alternatively, the client wireless device 20 need not disconnect after registration and can proceed straight to the waiting room 250 after registration 220.

For those client wireless devices 20 which have pre-registered before the event start time, a reminder message via SMS or other method may be sent to the registered wireless device 20 by the notification server 40 a short time before the event start time. The reminder message may contain a link to the address of the event server 10 so that the participant may select the link (preferably by one click) to enter the game at the appropriate time.

Once logged on a player will be asked to agree to pay to enter and will then proceed to the waiting room. The waiting room page signals received by the client wireless device serves two purposes. First the synchronisation of the client devices with the event server and second the maintenance of a live connection (some wireless devices disconnect or “time out” if there is no response or no new page signals are sent for a predetermined time, say 30 seconds). This is achieved by the use of a timer control object within the waiting room page signal. The timer control object win trigger, after a predetermined time, a request to the event server for a new waiting room page signal. Synchronisation with the event server is achieved by the event server automatically converting requests for waiting room page signal to requests for interactive event page signals on detecting that the event start time has been reached. A live connection is maintained by having the timer control objects trigger a new page signal request within the predetermined “time out” period of the client wireless devices.

The waiting room process and indeed the other event server processes are based on a connectionless protocol utilizing so called cookieless session tracking or URL rewriting (cookie based session tracking is not in general supported by wireless devices). With URL rewriting, every link contained in a page signal received by the client wireless device includes an embedded session identification string that allows the event server to identify the client wireless device when new page signals are requested.

Following the waiting room step, as a result of the synchronisation with the event server, client wireless devices will automatically begin to receive interactive event page signals at the interactive event start time.

Following the event start, waiting room page requests are directed by the event server 10 to pages containing an event prompt containing a multiple choice question (interactive event page signals) and a mechanism whereby a response (client wireless reply signal) to the prompt may be detected and stored. At game time exactly the same first question is distributed to all players. The question page signals are sent after a client reply wireless signal is sent to the previous question or a next page request signal is sent by the registered client wireless device. This minimizes the chance of the client wireless device 20 timing out. In the illustrative example, all participating client wireless devices are sent the same interactive event page signals and in the same order.

The players have before the end of the interactive event to complete all the questions. A client responding to all event prompts prior to the event finish time receives one or more waiting room pages 270. A client not responding to all event prompts prior to the event finish receives a page indicating that the event has finished and that no further responses will be accepted.

The event server 10 monitors which interactive event page signals have been sent to the client wireless devices 20 and which wireless reply signals have been sent by the client wireless devices 20 in answer to which interactive event page signals. In case of accidental disconnection from the event server 10, on re-connection between the client wireless device 20 and the event server 10, the client wireless device 20 can be sent only those interactive event page signals not previously downloaded or those on which reply signals have not yet been sent.

At the end of the interactive event the client may review the event data 280 including event statistics. Other information, which may be viewed after the event are the client wireless device score, scores that win prizes and sizes of prizes. Also information about whether the client wireless device has won a prize and if so how to collect can be received. At the end of the game, players can view answers to questions, register for next week's game, and send the URL for the site to a friend or link to sponsors mobile internet sites.

Prizes are calculated according to an algorithm that will share out the prize money available (say 50% of entry fees), depending on the number of entrants and distribution of scores, either 3, 4 or 5 different scores win prizes. Scores of perhaps 17/20 win smaller prizes of perhaps $10 while a small number of top scores receive substantial prizes.

Winners of higher prizes are sent a confirmation number via the notification server 40, and asked to dial a telephone number. They need to quote their unique identification code (telephone number) and the confirmation number and provide addresses for cheques to be sent or details for direct money transfer 290.

FIG. 3 depicts the event server deamon process which executes automatically without any operator input in the event server 10.

Prior to the event, event data is received 110 by the event server 10 from the administrator client station 50. Some of that data, such as event, start and finish times, can be downloaded by client wireless devices 20. Other information, such as the interactive event page signals (questions and answers), are not available to client devices 20. The event server 10 is then open to connection by client wireless devices 20 and for registration purposes 120 as descnied above. Registration details such as client wireless device unique identification code and wireless device type are stored in a database.

A short while (perhaps 2 minutes) before the start of the event, the event server daemon automatically sends reminders 130 through the notification server 40 to the registered client wireless devices 20. The event server 10 is open to connection from registered client devices 20 and event start synchronization (waiting room) begins 150. This synchronization is based on the sending of waiting room pages.

At the start of the event an interactive event page signal (a question with a set of possible answers) is sent 160. After a reply signal or a next page signal sent by a client wireless device 20 is detected the reply signal (the participants answer) is stored and the next question is sent. That loop is repeated until all of the questions have been answered or until the event stop time is reached.

After the interactive event, the responses of all of the client wireless devices are evaluated 170 and prizes calculated 180. At this stage a summary of the results can be sent to the client wireless devices 20 including information on how to claim prizes 190.

It will be apparent to one skilled in the art that the sending of the reminder notifications and the execution of the response evaluation and results calculation process can be implemented through use of a polling technique that compares the value returned by the system clock with the time specified for the execution of these tasks.

FIG. 4 depicts diagrammatically one embodiment of a software system suitable for configuring the event server 10, as depicted in FIG. 1 for performing a method according to the invention In particular, FIG. 4 depicts a software system that includes basic network services 11, an HTTP server processor 12, a page generation process 13, the event server deamon 14 (of FIG. 3) and a database server process 15. The HTTP server process 12 listens for client requests forwarded by the gateway servers 30 from the client wireless devices 20. On receipt of a request the HTTP server process 12 will invoke the page generation process 13 to generate a response to the request. The response generated will be dependent on the particular request, the capabilities of the client wireless device (if known and dependent on the detection of the type of wireless device), the status of the event (before, during, after) and the event content. Further depicted in FIG. 4 is the event server deamon process 14 (shown in detail in FIG. 3), with which the page generation process 13 is able to interact in order to query for event status information and event content and to insert response data. Additionally, a database server process 15 is depicted and shown to interact with the event server daemon 14, providing event content and storing client responses.

In one embodiment of the software system the HTTP server process 12 can be Apache, the page generation process 13 can be a Java Servlet engine, the database process 15 can be IBM's DB2 and the event server daemon 14 can be a Java RMI server implemented to operate as a system working according to the invention.

FIG. 5 depicts a possible embodiment of the gateway servers 30 depicted in FIG. 1. It will be obvious to one skilled in the art that the gateway servers 30 may be comprised of conventional computer hardware and software. The gateway servers 30 consist of a server system for a plurality of modem devices 300, remote access software service 310, a WAP gateway process 320 and basic network services 330. The remote access software server 310 permits wireless client devices 20 to create a temporal network connection to the gateway server 30. The WAP gateway process 320 listens for requests from the client wireless devices 20 and forwards the requests to the event server 10 via the wide area network (WAN) connection. Responses from the event server 10 are processed and returned to the client wireless devices 20. In order that the caller's unique identification code (the phone number) be received by the event server, the remote access software must detect the code and make it available programmatically to the WAP gateway software process so that it may be included in requests to the event server. Detection of the caller line ID is possible through use of standard HAYES modem commands. One example of remote access software that makes available the caller line ID is Lucent's Radius authentication server. Further, use of standard cryptographic and authentication mechanisms such as the secure socket layer (SSL) to communicate with the event server 10 can provide a method whereby the device uniquely and reliably identifies itself to the event server. In such an embodiment the unique identification code can be used in the registration/event start notification process 220, 130 as described above, and for billing purposes described below. Furthermore, the WAP gateway process 320 may determine the client wireless device type.

FIG. 6 illustrates the administrator station 50 interface of FIG. 1. In FIG. 6 the sequence of actions both prior and subsequent to the event are illustrated. Prior to an event the administrator will first create the event 510, upload the interactive event page signals 520 and evaluation criteria and specify start and end times 530 of the event. Subsequent to the event the administrator may download result information 540 and may vary the results calculation, view participant feedback 550 and review the event statistics 560 (participants, responses, event server performance data etc). Further, in a case that an error or inconsistency is discovered in the event content, the administrator is able to amend the evaluation criteria 570 and execute a re-evaluation of participant responses 580. A website is provided where users can read information about the events, register or submit a query or complaint 300. In the event of certain complaints, the website processes these claims automatically and is able to generate instruction to the mobile operator to re-credit the user's telephone bill with the entry fee.

FIG. 7 illustrates the basic structure of event server database. The structure depicted is only given as an example and can be easily created with one of many widely available database products implemented by basic SQL (standard query language) functionality such as IBM's DB2 or Oracle 8i. Depicted in FIG. 7 are five data base tables: event 700, participant 710, prompt 720, response 730 and result 740.

The event table 700 contains data representative of events scheduled to execute on the event server. The event table 700 contains fields representative of the event ID (unique identifier by which other tables may reference said event), the event start (the time at which the event will start) and the event finish (the time at which the event will finish).

The prompt table 720 contains data representative of event prompts (interactive event page signals) to form part of the event. The prompt table 720 contains fields representative of the event to which this prompt belongs, the position of the prompt within the event (i.e. question number), the prompt objectives (i.e. the question and multiple choice answers), and evaluation criteria (i.e. the correct answer) with which client response may be valued. It is understood that the prompt may contain alphanumeric text, static images, video images, audio data or any combination thereof The participant table 710 contains data representative of participants participating in events. The participant table 710 contains fields representative of participant ID (a unique identity by which the other tables may reference the participant) the name of the participant and wireless client device address (i.e. unique identification code) of the device used to participate in the event (in a specific embodiment this can be the telephone number of the wireless client device).

The response table 730 contains data representative of a participant response to a prompt forming part of an event. The response table 730 contains fields representative of the event in which the response is made, the prompt to which the response corresponds, the participant making the response and the response itself.

The result table 740 contains the workings of the evaluation step 170.

Participants can be billed for participating in the interactive event using a method which takes advantage of the ability of the event server 10 to detect the unique identification code of the client wireless device 20. If the client wireless device has a service provider (such as a mobile telephone provider) charges for those participating in the billable interactive event can be sent directly to that service provider. This is effected by, during registration, detecting from the client wireless device registration details, which include the unique identification code, and details of the service provider. Then, when the registered client wireless device 20 participates in a billable event provided by the event server 10, the event server 10 looks up the unique identification code of the client wireless device 20 and generates a set of billing instructions based on the registration details and forwards the billing instructions to the service provider.

### DESCRIPTION—ALTERNATIVE EMBODIMENTS

Although the invention is described in relation to a multiple choice quiz game the invention is equally applicable to numerous other types of interactive event. For example a political discussion show on the television whereby users are able to give their opinions on certain topics at the start of and/or during the show. Another example for which the invention might be used is a television dating game where viewers are able to vote for and eliminate or pair off individual couples. The event could also be a public sporting or entertainment event, which the participant wishes to view using their wireless device.

Other features which may be available for the quiz application are allowing client wireless devices to view a summary of responses submitted so far by other client wireless devices 20, allowing client wireless devices 20 to navigate back a limited number of pages and re-enter responses a limited number of times.

The event clock, which triggers the start and end of the event, may also be used to trigger intermediate sub-events during the event according to a timetable.

Virtual teams may be formed such that the team is able to register as a team, each member of the team using a registered client wireless device. The team may nominate a leader and have intra-team interactivity during the game, for example by showing the leader some of the responses from the team, or by allowing leader to nominate a team member to play. The players may also register a degree of certainty in their responses.

What has been described in detail herein above are methods and apparatus meeting all of the afore stated objectives. As previously indicated, those skilled in the art will recognize that the foregoing description has been presented for the sake of illustration and description only. It is not intended to be exhaustive or to limit the invention to the precise from disclosed, and obviously many modifications and variations are possible in light of the above teaching.

The embodiments and examples set forth herein were presented in order to best explain the principles of the instant invention and its practical application to thereby enable others skilled in the are to best utilize the instant invention in various embodiments and with various modifications as are suited to the particular use contemplated.

It is, therefore, to be understood that the claims appended hereto are intended to cover all such modifications and variations which fall within the true scope and spirit of the invention.

We claim:

1. A method of registering a client wireless device, comprising the steps of:
operating a registration server for generating registration page signals;
allowing at least one gateway server to connect to said registration server;
allowing a client wireless device with a unique identification code to connect to said registration server through said gateway server;
sending said client wireless device said registration page signals;
detecting said unique identification code;
registering said unique identification code in response to receipt by said registration server of a registration request signal from said client wireless device by storing said unique identification code in a database of said registration server; and
disconnecting said client wireless device connection to said registration server and retaining said unique identification code in said database.

2. A method according to claim 1, wherein said registration page includes a registration button or link which, when selected by said client wireless device, sends said registration request signal to said registration server.

3. A method according to claim 2, wherein said registration button or link is selectable by one user action on said wireless device.

4. A method according to claim 1, wherein, on receipt of a registration request signal, said registration server automatically detects said unique identification code.

5. A method according to claim 1, wherein a user of said client wireless device enters said unique identification code before sending said registration request signal.

6. A method for notifying a client wireless device of an impending event, comprising the steps of:
operating an event server for registering client wireless devices and generating event page signals;
allowing at least one gateway server to connect to said event server;
providing a registration process for registering client wireless devices before said event;
allowing registered client wireless devices to connect to said event server through said at least one gateway server to participate in said event;
providing a notification server connected to said event server; and
sending, through said notification server, a predetermined time before said event, a reminder message to said registered client wireless devices not connected to said event server.

7. A method according to claim 6, further comprising the steps of:
sending connected and registered client wireless devices event page signals during said event;
detecting client reply signals sent by registered client wireless devices in response to said sent event page signals, during said event; and
storing said client reply signals.

8. A method according to claim 7, wherein said sending takes place in response either to detection of a client reply signal, to detection of a client next page request signal or to an event start signal.

9. A method according to claim 7, wherein all connected and registered client wireless devices are sent the same event page signals and in the same order.

10. A method according to claim 7, further comprising the step of:
processing said detected client reply signals during and/or after said event.

11. A method according to claim 10, further comprising generating and sending result page signals, based on said processing step.

12. A method according to claim 7, further comprising the step of sending, through said notification server, prize messages generated on the basis of said processing step to at least one of said registered wireless devices.

13. A method according to claim 7, wherein said event server generates waiting room page signals, and
said method further comprises the step of sending connected registered wireless devices waiting room page signals after connection and the before said event starts.

14. A method according to claim 7, wherein said event server generates waiting room page signals; and
said method further comprises the step of sending connected registered wireless devices waiting room page signals after responses have been received for all event page signals comprising the said event and before said event ends.

15. A method according to claims 7, wherein at least one of said page signals includes a timer control object which automatically includes a new page request signal to said event server after a predetermined time.

16. A method according to claim 7, further comprising the step of monitoring the progression of client wireless devices through said event by tracking which event page signals have been sent and which client wireless reply signals have been detected.

17. A method according to claim 16, wherein, if connection between said client wireless device and said event server breaks during said event, on re-connection, event page signals not previously sent or on which client reply signals have not been detected, are sent.

18. A method according to claim 7, further comprising the step of providing said event server with a timetable for coordinating system tasks forming part of said event.

19. A method according to claim 7, further comprising the step of allowing at least one client station to connect to said event server.

20. A method according to claim 7, further comprising the step of providing said event server with a database containing the content of said event and responses from participants.

21. A method according claim 7, further comprising the step of providing said event server with a database containing information identifying said registered client wireless devices.

22. A method according to claim 7, comprising the step of providing said event server with a database containing information regarding the hardware capabilities of said registered client wireless devices.

23. A method according to claim 7, wherein said notification server is an SMS server.

24. A method according to claim 7, wherein said notification server is a WAP gateway implementing the WAP 1-2 Push Access Protocol.

25. A method according to claim 7, wherein said reminder message includes a hyper-link, said hyper-link providing a short cut for connection to said event server.

26. A method according to claim 7 wherein said event is an interactive event.

27. A method according to claim 7, wherein said step of providing a registration process comprises:
allowing client wireless devices with a unique identification code to connect to said event server through at least one gateway server;
detecting said unique identification code; and
registering said client wireless device by storing said unique identification code in response to receipt by said event server of a registration request signal from said client wireless device.

28. A method according to claim 27, wherein said notification server identifies said registered client wireless devices by said unique identification code.

29. A method according to claim 1 or 27, wherein said unique identification code of said client wireless device is an unique identification code of a switched communications system.

30. A method according to claim 29, wherein said switched communications system is a mobile cellular telephone system.

31. A method according to claim 30, wherein the overlying protocol of said client wireless device is WAP.

32. A method according to claim 1 or 27, wherein said unique identification code is a caller line identity.

33. A method according claims 1 or 27, further comprising, on connection of said client device with said server, the step of detecting the type of client wireless device.

34. A method for notifying a client wireless device of an impending event as hereinbefore described with reference to and as illustrated in the accompanying drawings.

35. A method of registering a client wireless device as hereinbefore described with reference to and as illustrated in the accompanying drawings.
